(19) United States
(12) Patent Application Publication
(10) Pub. No.: US 2023/0252492 A1
(43) Pub. Date: Aug. 10, 2023

(54) RECYCLING PACKAGE UNIT AND SYSTEM

(71) Applicant: Kristen Andrew VEKVED, Beaumont (CA)

(72) Inventor: Kristen Andrew VEKVED, Beaumont (CA)

(21) Appl. No.: 17/592,974

(22) Filed: Feb. 4, 2022

(51) Int. Cl. G06Q 30/02; B65F 1/14

(52) U.S. Cl. CPC G06Q 30/02; B65F 1/1426; B65F 2210/128; B65F 2210/172; B65F 2210/184

(57) ABSTRACT

A recycling package unit is provided. The unit is for compacting and storing one or more recyclable goods and communicating load metrics between a user and one or more waste management services. The unit comprises a lid consisting of a compactor partially contained within the lid optionally powered to extend downwards into the container to compact the recyclable goods and retract back into the lid. An activation switch and a display are on the front face of the lid. A computing device, having a weight measurement device, being wirelessly coupled to the display and a database through a network server via Internet. The computing device is capable of transmitting one or more scripts to said display to be visually presented to said user and transmitting one or more measurement data of said compacted recyclable goods obtained by the weight measurement device to said database.

### FIELD OF THE INVENTION

The present disclosure relates to a recycling package unit, more specifically, but not by way of limitation, more particularly to a recycling package unit and system for storing, compacting and facilitating pickup and payment transactions for pickup and deposit.

### BACKGROUND

Any discussion of the related art throughout the specification should in no way be considered as an admission that such related art is widely known or forms part of common general knowledge in the field.

C.N. Pub. No. 110,155,571 A (Xu) discloses a self-cleaning dustbin. Shortcomings include an inability to use in a small-scale, household setting, inability to compact recyclable materials, an inability to weigh compacted materials, an inability to expel liquid within the containment apparatus, an inability to coordinate pickup of the compacted recyclable materials between a user and a waste management service, an inability to facilitate payment of pickup of the compacted recyclable materials between a user and a waste management service, an inability to facilitate payment of deposit for the picked up compacted recyclable materials between a user and a waste management service and an inability to facilitate effortless and rapid maintenance to the collection apparatuses.

U.S. Pub. No. 2012/0029985 A1 (Wilson et al.) discloses a system and method for receiving and managing recyclable materials. Shortcomings include an inability to use in a small-scale, household setting, inability to compact recyclable materials, an inability to expel liquid within the containment apparatus, an inability to facilitate payment of pickup of the compacted recyclable materials between a user and a waste management service, an inability to facilitate payment of deposit for the picked up compacted recyclable materials between a user and a waste management service and an inability to facilitate effortless and rapid maintenance to the containment apparatus.

U.S. Pub. No. 2013/0024252 A1 (Sicklick et al.) discloses a system and method for monetizing recyclable plastics. Shortcomings include an inability to use in a small-scale, household setting, an inability to expel liquid within the containment apparatus and an inability to facilitate effortless and rapid maintenance to the containment apparatus.

U.S. Pub. No. 2013/0075468 A1 (Wadden et al.) discloses a system for receiving recyclable items. Shortcomings include an inability to use in a small-scale, household setting, inability to compact recyclable materials, an inability to weigh compacted materials, an inability to expel liquid within the containment apparatus and an inability to facilitate effortless and rapid maintenance to the containment apparatus.

U.S. Pub. No. 2017/0372272 A1 (Wadden et al.) discloses a repository for recyclable containers. Shortcomings include an inability to use in a small-scale, household setting, inability to compact recyclable materials, an inability to expel liquid within the repository, an inability to facilitate payment of pickup of the compacted recyclable materials between a user and a waste management service, an inability to facilitate payment of deposit for the picked up compacted recyclable materials between a user and a waste management service and an inability to facilitate effortless and rapid maintenance to the repository.

U.S. Pub. No. 2020/0189844 A1 (Sridhar) discloses a trash collection device and recycling system. Shortcomings include an inability to facilitate payment of deposit for the picked up compacted recyclable materials between a user and a waste management service and an inability to facilitate effortless and rapid maintenance to the trash collection device.

W.O. Pub. No. 2019/162710 A1 (Stengos) discloses a waste collection bin with advanced features. Shortcomings include an inability to compact recyclable materials, an inability to expel liquid within the containment apparatus, an inability to coordinate pickup of the compacted recyclable materials between a user and a waste management service, an inability to facilitate payment of pickup of the compacted recyclable materials between a user and a waste management service, an inability to facilitate payment of deposit for the picked up compacted recyclable materials between a user and a waste management service and an inability to facilitate effortless and rapid maintenance to the collection apparatuses.

U.S. Pat. No. 5,072,833 A (Hansen et al.) discloses a method of collecting recyclable materials and separating recyclable materials from household and commercial refuse for recycling at a recyclable material recovery facility. Shortcomings include an inability to expel liquid within the collection apparatus, an inability to facilitate payment of pickup of the compacted recyclable materials between a user and a waste management service, an inability to facilitate payment of deposit for the picked up compacted recyclable materials between a user and a waste management service and an inability to facilitate effortless and rapid maintenance to the collection apparatus.

U.S. Pat. No. 5,425,456 A (Erickson) discloses a waste collection and separation apparatus positioned for collecting recyclable and compostable waste materials. Shortcomings include an inability to use in a small-scale, household setting, inability to compact recyclable materials, an inability to weigh compacted materials, an inability to expel liquid within the containment apparatus, an inability to coordinate pickup of the compacted recyclable materials between a user and a waste management service, an inability to facilitate payment of pickup of the compacted recyclable materials between a user and a waste management service, an inability to facilitate payment of deposit for the picked up compacted recyclable materials between a user and a waste management service and an inability to facilitate effortless and rapid maintenance to the collection apparatuses.

U.S. Pat. No. 10,406,564 B1 (Al-Ateeq) discloses a storing waste receptacle for sorting and storing different types of waste items. Shortcomings include an inability to compact recyclable materials, an inability to weigh compacted materials, an inability to expel liquid within the storing waste receptacle, an inability to coordinate pickup of the compacted recyclable materials between a user and a waste management service, an inability to facilitate payment of pickup of the compacted recyclable materials between a user and a waste management service, an inability to facilitate payment of deposit for the picked up compacted recyclable materials between a user and a waste management service and an inability to facilitate effortless and rapid maintenance to the storing waste receptacle.

U.S. Pat. No. 10,564,029 B2 (Waite et al.) discloses a waste container with weight-measurement system for large-scale waste containers. Shortcomings include an inability to use in a small-scale, household setting, an inability to expel liquid within the waste container, inability to compact recyclable materials, an inability to facilitate payment of pickup of the compacted recyclable materials between a user and a waste management service, an inability to facilitate payment of deposit for the picked up compacted recyclable materials between a user and a waste management service and an inability to facilitate effortless and rapid maintenance to the waste container.

All documents cited herein are incorporated by reference.

It is clear that there exists a need for a recycling package unit for storing, compacting and facilitating pickup and payment transactions for pickup and deposit. More specifically, but not by way of limitation, more particularly there is a need for a recycling package unit and system that may be employed to store recyclable goods, compact recyclable goods, weigh the compacted recyclable goods and send this information to one or more waste management services, coordinate pickup of the compacted recyclable goods between a user and a waste management service, facilitate payment of pickup of the compacted recyclable goods between a user and a waste management service, facilitate payment of deposit for the picked up compacted recyclable goods between a user and a waste management service, expel liquid contained within the recycling package unit to reduce odors and facilitate effortless and rapid maintenance to the recycling package unit.

The disclosure proposes a recycling package unit and system for storing, compacting and facilitating pickup and payment transactions for pickup and deposit that overcomes disadvantages inherent in the existing devices and systems. As such, the general purpose of the present invention, which will be described subsequently in greater detail, is to provide a new and improved a recycling package unit for storing, compacting and facilitating pickup and payment transactions for pickup and deposit, which provides the advantages and overcomes the aforementioned disadvantages.

### BRIEF SUMMARY

It is an object of the invention to provide recycling package unit.

In accordance with an aspect of the invention, there is provided a recycling package unit, for compacting and storing one or more recyclable goods and communicating load metrics between a user and one or more waste management services, comprising: a lid coupled to a container; said lid consisting of a compactor partially contained within said lid that is optionally powered to extend downwards into said container to compact said one or more recyclable goods and retract back into said lid, an activation switch and a display on a front face of said lid and a power chord exiting from a rear face of said lid, said compactor comprising a telescopic member affixed to a top of a compactor plate and said compactor, said activation switch, said display and said power chord electrically coupled; and said container consisting of an input access door above an output access door coupled to a front face of an exterior wall of the container, an interior cavity surrounded by an interior wall having a base plate consisting of a plurality of holes affixed at the base of said interior cavity that is access by said input access door and said output access door, an interior lining enclosed between said interior walls and said exterior walls and a computing device and a drain spout coupled to a bottom of said exterior walls, said drain spout connected to said interior lining such that any liquid passed through said plurality of holes in said base plate and contained within said interior lining may be discharged via a release valve affixed to said drain spout and said computing device having a weight measurement device and being wirelessly coupled to said display and a database through a network server via Internet; wherein said computing device is capable of transmitting one or more scripts to said display to be visually presented to said user and transmitting one or more measurement data of said compacted recyclable goods obtained by said weight measurement device to said database.

In accordance with another aspect of the invention, there is provided a system for distribution of one or more compacted recyclable goods output from a recycling package unit, the system comprising: a network coupled to a database, said network further coupled to one or more smart devices from one or more users and one or more waste management services and a computing device from said recycling package unit via Internet, wherein one or more measurement data obtained by said computing device is transmitted and stored onto said database; and an application on said one or more smart devices capable of displaying and transmitting one or more measurement data and one or more programming instructions to said one or more smart devices, said application.

### BRIEF DESCRIPTION OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

Embodiments will now be described, by way of example only, with reference to the attached figures, wherein the figures:

FIG. 1A illustrates a perspective view of a recycling package unit, in accordance with one embodiment.

FIG. 1B illustrates a perspective view of a recycling package unit, in accordance with one embodiment.

FIG. 2A illustrates a front view of a recycling package unit, in accordance with one embodiment.

FIG. 2B illustrates a side view of a recycling package unit, in accordance with one embodiment.

FIG. 2C illustrates a sectional view of a recycling package unit, in accordance with one embodiment.

FIG. 3A illustrates a perspective view of a recycling package unit, in accordance with one embodiment.

FIG. 3B illustrates a perspective view of a recycling package unit, in accordance with one embodiment.

FIG. 3C illustrates a perspective view of a recycling package unit, in accordance with one embodiment.

FIG. 3D illustrates a sectional view of a recycling package unit, in accordance with one embodiment.

FIG. 3E illustrates a sectional view of a recycling package unit, in accordance with one embodiment.

FIG. 3F illustrates a sectional view of a recycling package unit, in accordance with one embodiment.

FIG. 3G illustrates a perspective view of a recycling package unit, in accordance with one embodiment.

FIG. 4A illustrates a perspective view of a recycling package unit, in accordance with one embodiment.

FIG. 4B illustrates a perspective view of a recycling package unit, in accordance with one embodiment.

FIG. 5 illustrates a high-level view of a system for distribution of output from a recycling package unit, in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

The present invention provides a recycling package unit and system that may be used with many alternative embodiments. As such, the general purpose of the present invention, which will be described subsequently in greater detail, is to provide a new and improved a recycling package unit for storing, compacting and facilitating pickup and payment transactions for pickup and deposit, which provides the advantages and overcomes the aforementioned disadvantages.

A clean and straightforward solution to store, compact and dispose of recyclable goods such as, but not limited to, aluminum cans, plastic bottles and cardboard cartons. The recycling package unit may be employed to schedule pickups with a local waste management service to reduce effort for the user while encouraging the user to more efficiently recycle.

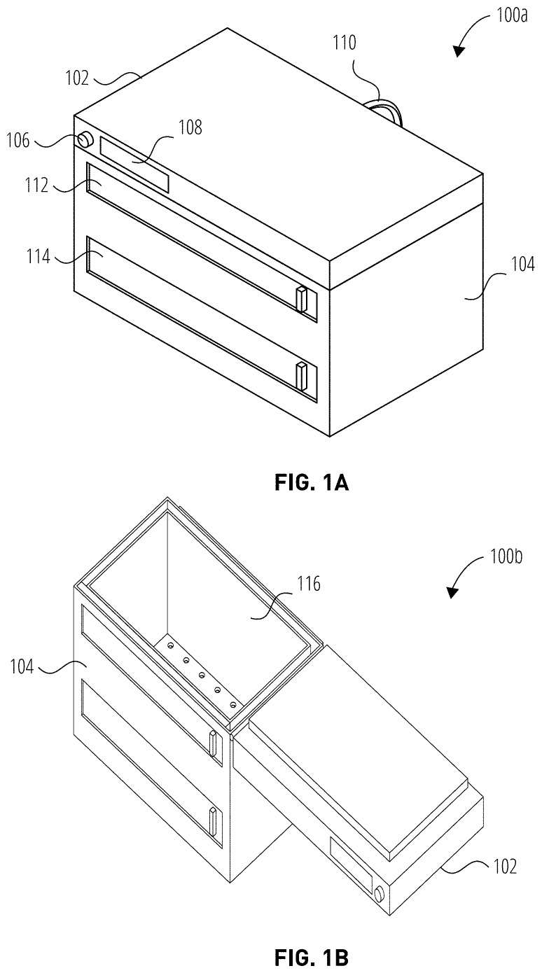

FIG. 1A illustrates a perspective view 100a of an exterior of the recycling package unit, according to some embodiments. In this embodiment, the recycling package unit is shown comprising a lid 102 coupled to a container 104. The lid 102 is shown resting on the container 104 and comprises an activation switch 106 and display 108 affixed to the front face of the lid 102 and a power chord 110 exiting out from the rear face of the lid 102. The lid 102 further comprises a compactor, not currently shown, within its interior that can be powered to extend into the container 104. The activation switch 106, the display 108, the compactor and the power chord 110 are all electrically coupled.

The container 104 is shown comprising an input access door 112 and an output access door 114 coupled to the face of the container 104, where the input access door 112 is oriented above the output access door 114. In some embodiments, the display 108 may be employed to display features such as, but not limited to power status, weight of the load contained within the recycling package unit and maintenance warnings for the user.

FIG. 1B illustrates a perspective view 100b of a recycling package unit, according to some embodiments. In this embodiment, the lid 102 is shown hingedly coupled to the exterior side of the container 104, with the interior cavity 116 of the container 104 in view. Alternatively, the lid 102 may be affixed to the container 104 in any relation known in the art. In other embodiments, the lid 102 is optionally coupled to the container 104 and may be removed for maintenance purpose pertaining to one or both of the lid 102 and container 104.

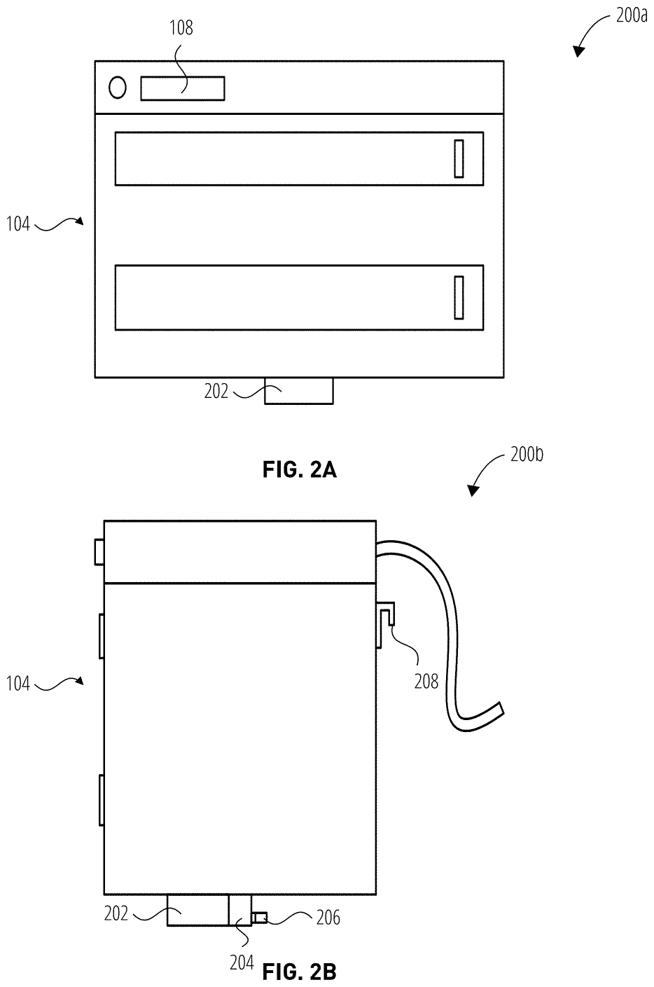

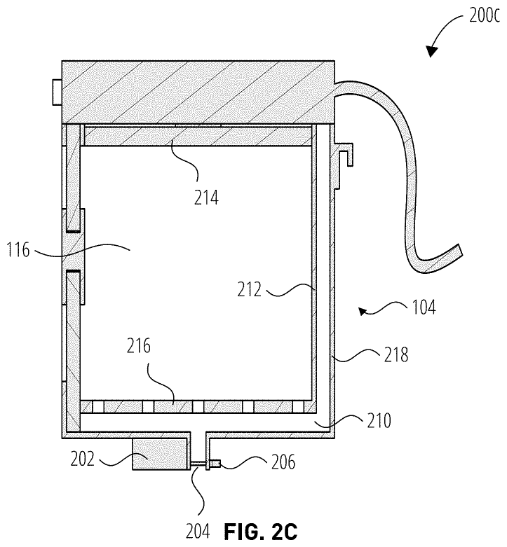

FIG. 2A illustrates a front view 200a of a recycling package unit, according to some embodiments. In this embodiment, a computing device 202 is shown affixed to the base of the container 104, which is coupled to a weight measurement device not shown. The computing device 202 is at least partially employed to measure the weight of recyclable goods that have been compacted within the recycling package unit. In some embodiments, the computing device 202 is wirelessly coupled to the display 108 to transmits one or more scripts to the display 108 to be visually presented to a user.

FIG. 2B illustrates a side view 200b of a recycling package unit, according to some embodiments. In this embodiment, a drain spout 204 is shown affixed to the base of the container 104 next to the computing device 202. The drain spout 204 is shown coupled to a release valve 206, which is employed to allow or prevent liquid substances contained within the recycling package unit to be discharged. Furthermore, a mounting apparatus 208 is shown affixed to the rear face of the container 104, which may be employed to house the recycling package unit off of the ground.

FIG. 2C illustrates a sectional view 200c of a recycling package unit, according to some embodiments. In this embodiment, the interior cavity 116 of the recycling package unit is shown surrounded by an interior wall 212, with a compactor plate 214 fully retracted to the top of the interior cavity 116 and a base plate 216 affixed at the base of the interior cavity 116.

Furthermore, an interior lining 210 is shown between the interior walls 212 and the exterior walls 218 of the container 104. In some embodiments, the base plate 216 has a plurality of holes which allow for any liquid contained within the inserted recyclable goods to be expelled out from the interior cavity 116 and into the interior lining 210. At the base of the container 104 is a drain spout 204 next to the computing device 202. The drain spout 204 is connected to the interior lining 210 such that any liquid contained within the interior lining 210 may be discharged via a release valve 206 affixed to the drain spout 204.

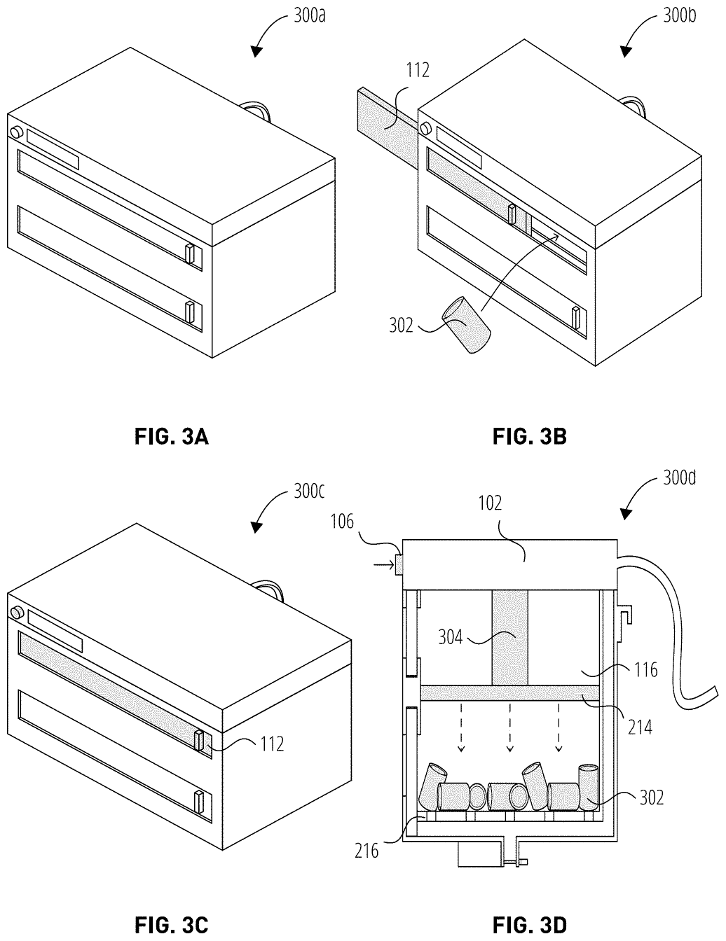

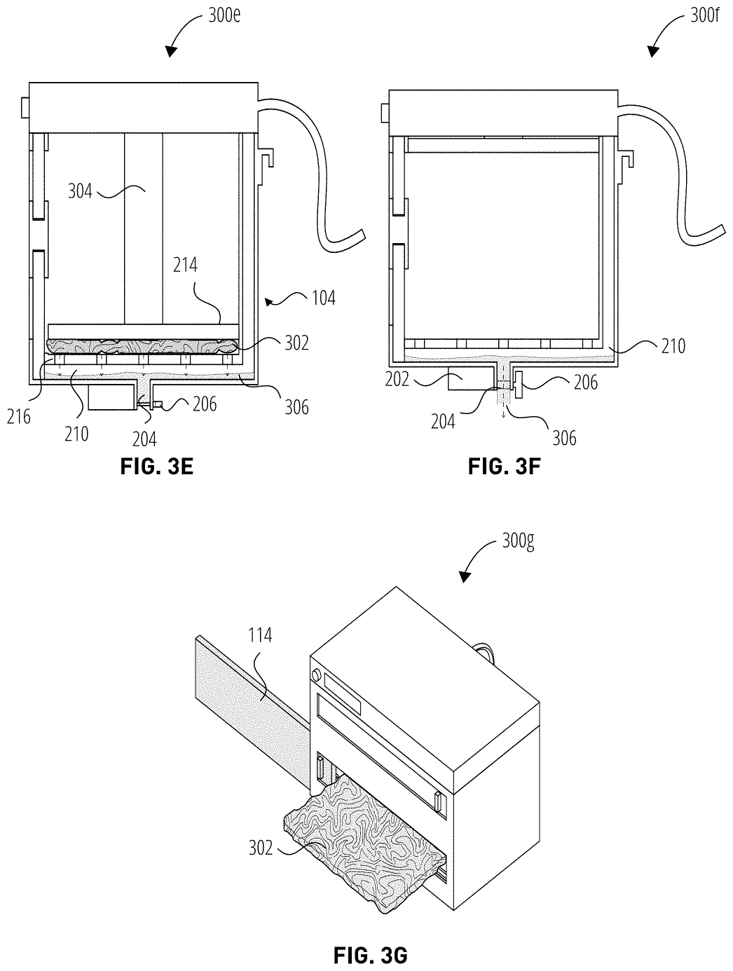

FIG. 3A illustrates a perspective view 300a of a recycling package unit prior to use, according to some embodiments.

FIG. 3B illustrates a perspective view 300b of loading a recycling package unit, according to some embodiments. In this embodiment, an input access door 112 is slid open and one or more recyclable goods 302 are inserted into the interior cavity 116 of the recycling package unit. Once inserted into the interior cavity 116, the recyclable goods 302 fall downward toward the base plate 216 where the recyclable goods 302 stack on the surface of the base plate 216.

FIG. 3C illustrates a perspective view 300c of loading a recycling package unit, according to some embodiments. In this embodiment, the input access door 112 is slid closed after the user has completed inserting the one or more recyclable goods 302 into the interior cavity 116 of the recycling package unit.

FIG. 3D illustrates a sectional view 300d of the compacting process of a recycling package unit, according to some embodiments. In this embodiment, a user presses the activation switch 106 which powers the compactor and initiates the process for the built-in compactor to crush the one or more recyclable goods 302 within the interior cavity 116. The compactor comprises a telescopic member 304 affixed to the top of a compactor plate 214, as shown. Once the compacting process has been initiated, the telescopic member 304 extends downward, from within the lid 102, towards the one or more recyclable goods 302 resting on the base plate 216.

FIG. 3E illustrates a sectional view 300e of the compacting process of a recycling package unit, according to some embodiments. In this embodiment, the telescopic member 304 is fully extended, causing the compactor plate 214 to significantly compact the one or more recyclable goods 302 resting on the base plate 216.

Also shown in this embodiment, a liquid 306 is discharged from the recyclable good 302 during their compression and is drains through the plurality of holes within the base plate 216 into the interior lining 210 below. The liquid 306 is shown primarily contained within the drain spout 204 due to the release valve 206 being in a closed position. The drain spout 204 is coupled to the interior lining 210 such that the drain spout 204 is the lowest point of the container 104.

FIG. 3F illustrates a sectional view 300f of the liquid 306 draining process of a recycling package unit, according to some embodiments. As shown in this embodiment, the liquid 306 that has pooled in the drain spout 204 from the interior lining 210 is discharged by opening the release valve 206. After the liquid 306 has been expelled, the user can activate the computing device 202 to weigh the compacted recyclable goods 302. This is an important feature to ensure accuracy when weighing the compacted recyclable goods 302, as well as removing odor from the recycling package unit. Furthermore, the user may sanitize the interior cavity 116 of the recycling package unit and utilize the drain spout 204 to discharge any liquid sanitizer.

FIG. 3G illustrates a perspective view 300g of the load removal process a recycling package unit, according to some embodiments. In this embodiment, the output access door 114 is slid open and the compacted recyclable goods 302 are extracted from the interior cavity 116 of the recycling package unit.

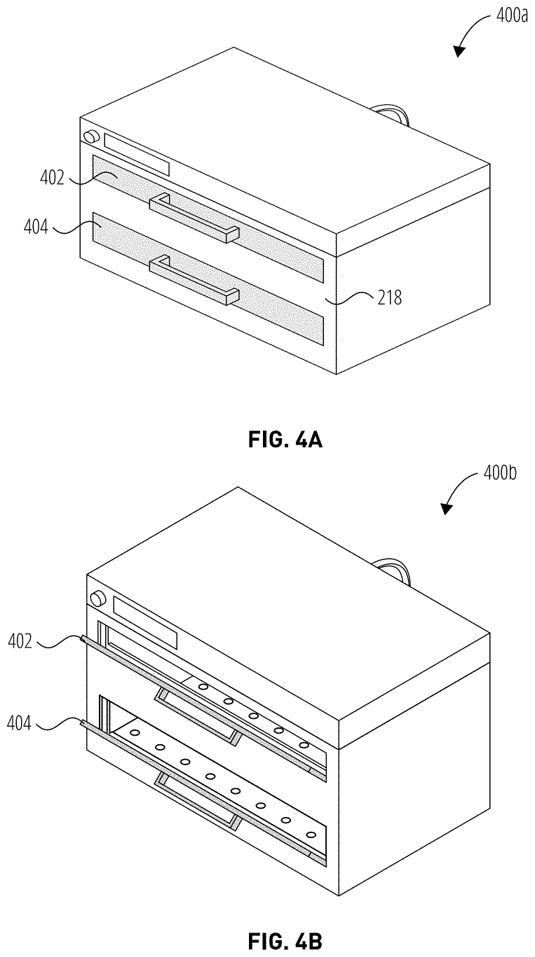

FIG. 4A illustrates a perspective view 400a of a recycling package unit, according to some embodiments. In this embodiment, the input access door 402 and the output access door 404 are hingedly coupled to the exterior wall 218 of the recycling package unit. The input access door 402 and the output access door 404 are shown in a closed position.

FIG. 4B illustrates a perspective view 400b of a recycling package unit, according to some embodiments. In this embodiment, the input access door 402 and the output access door 404 are in an opened position. In other embodiments, the input access door 402 and the output access door 404 may be any type of access doors known in the art.

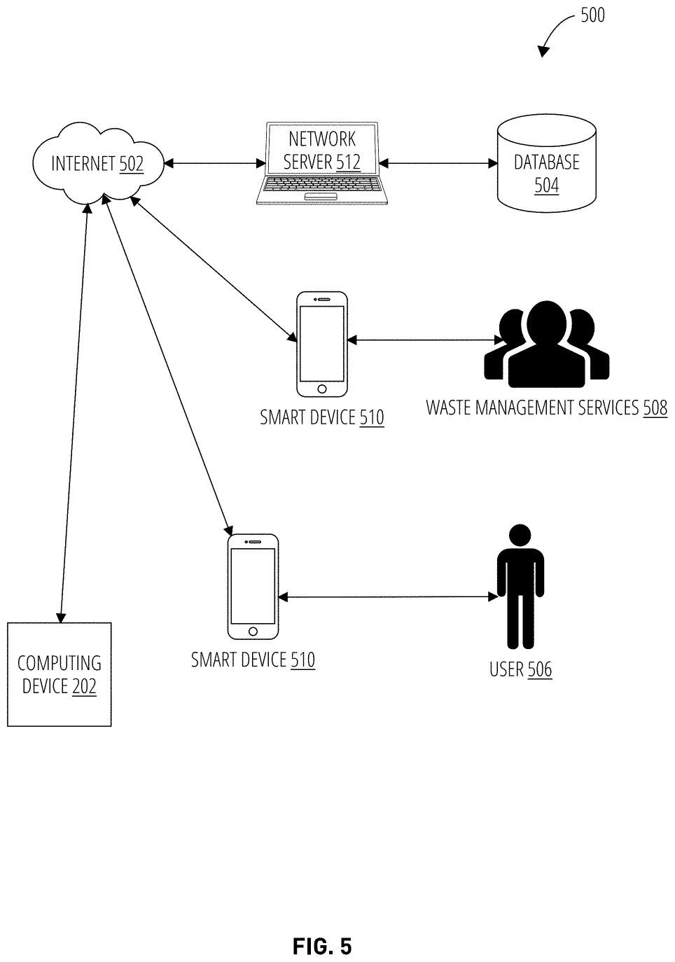

FIG. 5 illustrates a high-level view 500 of a system for distribution of output from a recycling package unit, according to some embodiments. In addition to providing a user 506 with the measurement for the weight of recyclable goods 302 within the recycling package unit and presenting the measurement on the display 108, the computing device 202 is connected to a network server 512 via the internet 502, where the measurement data is sent and stored onto a database 504 that is coupled to the network server 512. In some embodiments, maintenance warnings may be periodically sent to the computing device 202 to be presented on the display 108. In some embodiments, the maintenance warnings may be sent to the user 506 via a smart device 510.

The network server 512 is further optionally coupled to one or more users 506 via their smart devices 510, as well as one or more waste management services 508 via their smart devices 510. These connections enable one or more users 506 to coordinate pickup of their recyclable goods 302, process payment from the user 506 to the waste management services 508 for pickup and process payment from the waste management services 508 to the user 506 for the recyclable goods 302 based on the weight of the recyclable goods 302.

In some embodiments, the computing device 202 is coupled to an application on the one or more smart devices 510 capable of displaying and transmitting programming instructions to one or more users 506 and waste management services 508. These instructions include but are not limited to one or more pre-scheduled maintenance reminder, one or more pickup date, time and location and one or more payment transactions. This application can be further programmable to adjust for customized requests from one or more users 506 and one or more waste management services 508. For example, a user 506 may include the type of recyclable goods 302, such as aluminum cans, plastic bottles, and cardboard cartons that are associated with a submitted recyclable goods 302 weight and pickup request. This allows for waste management services 508 to adequately price out what the user 506 is owed for the returned recyclable goods 302.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. As can be understood, the examples described above are intended to be exemplary only.

The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The term “connected”, “attached”, “affixed” or “coupled to” may include both direct coupling (in which two elements that are coupled to each other contact each other) and indirect coupling (in which at least one additional element is located between the two elements).

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A recycling package unit, for compacting and storing one or more recyclable goods and communicating load metrics between a user and one or more waste management services, comprising:
a lid coupled to a container;
said lid consisting of a compactor partially contained within said lid that is optionally powered to extend downwards into said container to compact said one or more recyclable goods and retract back into said lid, an activation switch and a display on a front face of said lid and a power chord exiting from a rear face of said lid, said compactor comprising a telescopic member affixed to a top of a compactor plate and said compactor, said activation switch, said display and said power chord electrically coupled; and
said container consisting of an input access door above an output access door coupled to a front face of an exterior wall of the container, an interior cavity surrounded by an interior wall having a base plate consisting of a plurality of holes affixed at the base of said interior cavity that is access by said input access door and said output access door, an interior lining enclosed between said interior walls and said exterior walls and a computing device and a drain spout coupled to a bottom of said exterior walls, said drain spout connected to said interior lining such that any liquid passed through said plurality of holes in said base plate and contained within said interior lining may be discharged via a release valve affixed to said drain spout and said computing device having a weight measurement device and being wirelessly coupled to said display and a database through a network server via Internet;
wherein said computing device is capable of transmitting one or more scripts to said display to be visually presented to said user and transmitting one or more measurement data of said compacted recyclable goods obtained by said weight measurement device to said database.

2. The recycling package unit of claim 1, wherein said lid is optionally coupled to said container.

3. The recycling package unit of claim 1, wherein said container further comprises a mounting apparatus affixed to a rear face of said container.

4. The recycling package unit of claim 1, said lid is hingedly coupled to said exterior wall of said container.

5. The recycling package unit of claim 1, wherein said computing device is programmable to notify said user of a maintenance requirement.

6. The recycling package unit of claim 5, wherein said maintenance requirement is sent to said user via a smart of device.

7. The recycling package unit of claim 5, wherein said maintenance requirement is sent to said display.

8. The recycling package unit of claim 1, wherein said computing device is coupled to an application on one or more smart devices capable of displaying and transmitting said one or more measurement data and one or more programming instructions to said one or more smart devices.

9. A system for distribution of one or more compacted recyclable goods output from a recycling package unit, the system comprising:
a network coupled to a database, said network further coupled to one or more smart devices from one or more users and one or more waste management services and a computing device from said recycling package unit via Internet, wherein one or more measurement data obtained by said computing device is transmitted and stored onto said database; and
an application on said one or more smart devices capable of displaying and transmitting one or more measurement data and one or more programming instructions to said one or more smart devices, said application.

10. The system for distribution of one or more compacted recyclable goods output from a recycling package unit of claim 9, wherein one or more programming instructions includes one or more pre-scheduled maintenance reminders.

11. The system for distribution of one or more compacted recyclable goods output from a recycling package unit of claim 9, wherein one or more programming instructions includes scheduling pickup of one or more compacted recyclable goods between a user and one or more waste management services.

12. The system for distribution of one or more compacted recyclable goods output from a recycling package unit of claim 9, wherein one or more programming instructions includes scheduling pickup of one or more compacted recyclable goods between a user and one or more waste management services.

13. The system for distribution of one or more compacted recyclable goods output from a recycling package unit of claim 9, wherein one or more programming instructions includes one or more payment transactions between a user and one or more waste management services.

14. The system for distribution of one or more compacted recyclable goods output from a recycling package unit of claim 9, wherein one or more programming instructions includes inputting a type of said one or more compacted recyclable goods.
